(19) United States
(12) Patent Application Publication
(10) Pub. No.: US 2003/0092593 A1
(43) Pub. Date: May 15, 2003

(54) Superior surfactant system for laundry detergent composition based on alkyl benzene sulfonate and ethylene oxide/propylene oxide copolymer

(75) Inventors: Amjad Farooq, Hillsborough, NJ (US); Guy Broze, Grace-Hollogne (BE); Anne-Marie Misselyn, Etienne (BE); Donghui Wu, Somerset, NJ (US); Ammanuel Mehreteab, Piscataway, NJ (US); Alain Jacques, Blegny (BE); Jeffrey J. Mastrull, Middlesex, NJ (US)

Correspondence Address: Patent Department, Colgate-Palmolive Company, 909 River Road, P.O. Box 1343, Piscataway, NJ, 08855-1343, US

(73) Assignee: Colgate-Palmolive Company

(21) Appl. No.: 10/120,978

(22) Filed: Apr. 11, 2002

Related U.S. Application Data
(63) Continuation-in-part of application No. 09/685,649, filed on Oct. 10, 2000, now abandoned.
Application No. 09/685,649 is a continuation-in-part of application No. 09/332,774, filed on Jun. 14, 1999, now abandoned.
Application No. 09/332,774 is a continuation-in-part of application No. 08/959,207, filed on Oct. 28, 1997, now abandoned.

(51) Int. Cl. C11D 17/00

(52) U.S. Cl. 510/422; 510/424; 510/426

(57) ABSTRACT

A granular laundry detergent composition is described comprising (a) from about 1 to 60% by weight of an anionic surfactant consisting essentially of a water-soluble salt of an alkyl benzene sulfonate; and (b) an effective amount of a water-soluble triblock copolymer surfactant comprising groups of polyethylene oxide (EO) and polypropylene (PO) such as a PO/EO/PO type copolymer having a molecular weight in the range of from about 1,000 to about 15,000. A method of washing laundry with the laundry composition of the invention is also described.

This application is a continuation-in-part of copending U.S. Ser. No. 09/685,649 filed Oct. 10, 2000 which is a continuation-in-part of U.S. Ser. No. 09/332,774 filed Jun. 14, 1999 which in turn is a continuation-in-part of U.S. Ser. No. 08/959,207 filed Oct. 28, 1997, the disclosures of which are incorporated herein by reference.

### FIELD OF THE INVENTION

This invention relates to improved laundry detergent compositions containing alkyl benzene sulfonate as the principal anionic surfactant and which compositions are effective for the removal of oily and particulate soils. More particularly, this invention relates to laundry detergent compositions having improved detergency based on the combination of an alkyl benzene sulfonate surfactant and a triblock polymeric co-surfactant comprising ethylene oxide and propylene oxide groups as herein defined.

### BACKGROUND OF THE INVENTION

Block copolymers of ethylene oxide (EO) and propylene oxide (PO) are extensively described in the patent literature. Among the principal uses disclosed for such copolymers are improved grease removal when incorporated into liquid dishwashing detergent compositions; and as anti-redeposition agents in liquid and powder detergent compositions. These EO/PO type block copolymers are often identified as Pluronic® block copolymers marketed by BASF.

U.S. Pat. No. 4,904,359, for example, describes liquid dishwashing detergent compositions containing a combination of a polymeric surfactant comprising a hydrophilic group such as polyethylene oxide and a hydrophobic group such as polypropylene oxide, and an anionic surfactant such as alkyl sulfate or polyethoxylate sulfate. This combination is said to provide superior grease removal from tableware and kitchen utensils as a detergent composition. U.S. Pat. No. 5,167,872 describes a dishwashing liquid detergent composition comprising a polymeric surfactant as described in the aforementioned U.S. Pat. No. 4,904,359 wherein the composition further contains an anionic surfactant and a betaine surfactant.

In U.S. Pat. No. 4,724,095 there is described a detergent composition for washing textile fabrics comprising one or more principal types of copolymers , one of which is a copolymer of polyoxyethylene and polyoxyalkylene as an anti-redeposition agent. This type of copolymer is said to be marketed under the trademark “Pluronics”. U.S. Pat. No. 5,152,933 discloses the use of block copolymers of ethylene oxide and propylene oxide as a cosurfactant in detergent formulations containing mixed actives such as a combination of alkyl benzene sulfonate and ethoxylated alcohol. The presence of the block copolymers is said to enhance oily soil removal and clay soil removal from soiled fabrics in an automatic washing machine. Improvements are also said to be observed in formulations that contain only nonionic surfactants.

### SUMMARY OF THE INVENTION

In accordance with the present invention there is provided a granular laundry detergent composition comprising

(a) from about 1 to about 60% by weight of an anionic surfactant consisting essentially of a water-soluble salt of an alkyl benzene sulfonate;

(b) from 0.2% to no greater than 2%, by weight, of a water-soluble triblock copolymer nonionic surfactant comprising groups of polyethylene oxide and polypropylene oxide having the following structural formula:

(I) Aₓ B_{y} A_{z} or (II) Bₓ A_{y} B_{z} wherein A is a polyethylene oxide group, B is a polypropylene oxide group and each of x, y and z is a number within the range of from one to about 85, the molecular weight of the triblock copolymer being in the range of from about 1,000 to about 15,000 and the percentage, by weight, of polyethylene oxide in said triblock copolymer is from about 10 to about 80% of the molecular weight of the copolymer; and wherein said laundry detergent composition is free of (i) any anionic and nonionic surfactant other than as defined in (a) and (b) hereinabove, and (ii) free of any fatty acids; and

(c) from 0% to about 50%, by weight of a detergent builder.

In accordance with the process of the invention laundering of soiled or stained fabrics is effected by washing the fabrics to be laundered in an aqueous wash solution containing an effective amount of the above-defined laundry detergent composition.

The present invention is predicated on the discovery of significantly enhanced detergency attendant to the use of the above-described triblock copolymer in a single anionic surfactant system, namely, an alkyl benzene sulfonate surfactant. Contrary to the disclosed use of triblock copolymers in the prior art as a co-surfactant in formulations containing mixed actives, the present invention provides unexpected improvement in detergency, and particularly oily soil detergency, for formulations containing a single anionic surfactant in combination with a triblock copolymer in accordance with the invention. Moreover, it has been discovered that at levels of said triblock copolymer above 2%, by weight, the detergency of the detergent composition is adversely affected, hence, the maximum level of said triblock copolymer should be maintained at 2% or less, by weight. Accordingly, detergent compositions of the invention may be formulated to be cost-effective while providing good detergency performance relative to formulations which rely upon higher levels of actives to achieve substantially similar levels of detergency.

Unlike prior art disclosures describing the particular combination of fatty acids and triblock copolymer as a suds suppressor, the present compositions are free of such fatty acids.

### DETAILED DESCRIPTION OF THE INVENTION

The laundry detergent compositions of the invention contain a water-soluble salt of alkyl benzene sulfonate as the predominant or sole anionic surfactant. The alkyl benzene sulfonates useful herein contain from about 10 to 16 carbon atoms in the alkyl group in a straight or branched chain such as, for example, the sodium, potassium ammonium or substituted ammonium (such as mono, di and tri ethanolamine) or alkaline earth metal (such as calcium and magnesium) salts of higher alkyl benzene sulfonate. Especially preferred is sodium linear alkyl benzene sulfonate wherein the alkyl group is a straight chain alkyl group of 12 or 13 carbon atoms.

The weight percent of anionic surfactant in the laundry composition may vary from about 5 to about 50% and preferably is from about 15% to about 40%.

The nonionic water-soluble triblock copolymer of the invention has one of the two structural formulae represented above in (I) or (II). These copolymers are commerically available and are marketed, for example, by BASF Corporation under the trademark Pluronic®. A description of the preparation of these compounds is set forth in U.S. Pat. No. 2,674,619, the disclosure of which is incorporated herein by reference.

Preferred triblock copolymers for use herein are those wherein the weight of polyethylene oxide is from about 10% to about 80%, and most preferably from about 40% to about 80%, by weight, of the triblock copolymer. The average molecular weight of the copolymer is most usefully within the range of from about 1,100 to about 8,400.

The weight percent of triblock copolymer in the laundry composition is usually from about 0.1% to 5%, and preferably from about 0.2% to about 2%, by weight. A decrease in laundering efficacy is noted when the percent of triblock copolymer in the detergent composition is at a level of 2.5% or higher, by weight of the detergent composition.

Builder materials may advantageously be included in the present compositions and may comprise any suitable water soluble or water insoluble builder, either inorganic or organic, providing that it is useful as a builder for the particular detergent compounds that are employed. Such builders are well known to those of skill in the detergent art and include: alkali metal phosphates, such as alkali metal polyphosphates and pyrophosphates, including alkali metal tripolyphosphates; alkali metal silicates, including those of Na₂O:SiO₂ ratio in the range of 1:1.6 to 1:3.0, preferably 1:2.0 to 1:2.8, and more preferably 1:2.35 or 1:2.4; alkali metal carbonates; alkali metal bicarbonates; alkali metal sesquicarbonates (which may be considered to be a mixture of alkali metal carbonates and alkali metal bicarbonates); alkali metal borates, e.g., borox; alkali metal citrates; alkali metal gluconates; alkali metal nitrilotriacetates; zeolites, preferably hydrated zeolites, such as hydrated Zeolite A, Zeolite X and Zeolite Y; and mixtures of individual builders within one or more of such types of builders. Preferably the builders will be sodium salts and will also be inorganic. A highly preferred non-phosphate mixed water soluble and water insoluble builder composition comprises carbonate, bicarbonate and zeolite builders. Phosphate-containing builder systems will usually be based on alkali metal (sodium) tripolyphosphate and silicate builders, with such silicate being in relatively minor proportion.

Zeolite A-type aluminosilicate builder, usually hydrated, with about 15 to 25% of water of hydration is particularly advantageous for the present invention. Hydrated zeolites X and Y may be useful too, as may be naturally occurring zeolites that can act as detergent builders. Of the various zeolite A products, zeolite 4A, a type of zeolite molecule wherein the pore size is about 4 Angstroms, is often preferred. This type of zeolite is well known in the art and methods for its manufacture are described in the art such as in U.S. Pat. No. 3,114,603.

The zeolite builders are generally of the formula

(Na₂O)ₓ·(Al₂O₃)_{y}·(SiO₂)_{z}·w H₂O

wherein x is 1, y is from 0.8 to 1.2, preferably about 1, z is from 1.5 to 3.5, preferably 2 or 3 or about 2, and w is from 0 to 9, preferably 2.5 to 6. The crystalline types of zeolite which may be employed herein include those described in “Zeolite Molecular Series” by Donald Breck, published in 1974 by John Wiley & Sons, typical commercially available zeolites being listed in Table 9.6 at pages 747-749 of the text, such Table being incorporated herein by reference.

The zeolite builder should be a univalent cation exchanging zeolite, i.e., it should be aluminosilicate of a univalent cation such as sodium, potassium, lithium (when practicable) or other alkali metal, or ammonium. A zeolite having an alkali metal cation, especially sodium, is most preferred, as is indicated in the formula shown above. The zeolites employed may be characterized as having a high exchange capacity for calcium ion, which is normally from about 200 to 400 or more milligram equivalents of calcium carbonate hardness per gram of the aluminosilicate, preferably 250 to 350 mg. eg./g., on an anhydrous zeolite basis.

Other components may be present in the detergent compositions to improve the properties and in some cases, to act as diluents or fillers. Among the suitable fillers, the most preferred is sodium sulfate. Illustrative of suitable adjuvants are enzymes to further promote cleaning of certain hard to remove stains from laundry or hard surfaces. Among enzymes, the proteolytic and amylolytic enzymes are ordinarily most useful. Other useful adjuvants are foaming agents, such as lauric myristic diethanolamide, when foam is desired, and anti-foams, when desired, such as dimethyl silicone fluids. Also useful are bleaches, such as sodium perborate, which may be accompanied by suitable activator(s) to promote bleaching actions in warm or cold water. Flow promoting agents, such as hydrated synthetic calcium silicate, which is sold under the trademark Microcel® C, may be employed in relatively small proportions. Other adjuvants usually present in detergent compositions include fluorescent brighteners, such as stilbene brighteners, colorants such as dyes and pigments and perfume.

### EXAMPLE

The performance of two detergent compositions in accordance with the invention (A and B) was evaluated relative to a control composition (“control”) containing more elevated levels of polyphosphate builder and which was used at a higher dosage in the wash bath. The detergent compositions are shown below in Table 1 along with the dosage used in the detergency evaluation.

TABLE 1

| Component | Control | | A | | B | |
|---|---|---|---|---|---|---|
| Alkyl Benzene Sulfonate⁽¹⁾ | 27.4 | wt % | 29.6 | wt % | 29.6 | wt % |
| Triblock Polymer⁽²⁾ | — | | 0.53 | | 0.53 | |
| Sodium Tripolyphosphate (Na TPP · 6 | 22.5 | | 15.8 | | 15.8 | |
| H₂O) | | | | | | |
| Na₂SO₄ | 37.6 | | 40.6 | | 40.6 | |
| Na₂CO₃ | 12.5 | | 13.5 | | 13.5 | |
| Dosage | 102.2 | g/wash | 94.7 | g/wash | 94.7 | g/wash |
| | or | | | | | |
| | 1.59 | g/liter | 1.48 | g/liter | 1.48 | g/liter |

⁽¹⁾The linear alkyl benzene sulfonate (LAS) surfactant was a sodium salt of alkyl benzene sulfonic acid having a molecular weight of approx. 375.
⁽²⁾A different triblock copolymer marketed as Pluronic ® surfactant was used in each of compositions A and B, respectively: L64 and F68. Both are PO/EO/PO type copolymers. L64 is a copolymer having an average molecular weight of 2,900; and F68 is a copolymer having an A.M.W. of 8,400.

### Washing Protocol

The washing protocol was as follows: a set of soiled swatches (3″×4″) corresponding to either a standard 12 stain set or an oily stain set (as hereinafter described) was washed for 10 minutes in a U.S. Whirlpool washing machine (medium setting) at a temperature of 77° F. using water at 100 ppm hardness. The swatches were dried for 5 minutes in a Whirlpool electric dryer (high setting). The reflectance of the dried swatches was then measured by a Pacific Scientific XL800 Reflectometer. The reflectance (Rd) of each soiled swatch was measured prior to being washed and after washing and the % SRI (soil removal index) calculated as follows:

$$\% SRI = 100 \times \frac{[ Rd ( after washing ) - Rd ( before washing ) ]}{92 - Rd ( before washing )}$$

In this formula “92” is a standard value for clean cloth.

A difference in the value of % SRI of 3 or more is considered significant.

### Standard 12 Stains

The standard 12 stains used in this Example was comprised of 4 principal groups of stains: clays, oxidizables, enzymes and oily:

Clays:

(1) Piscataway clay (Cotton)

(2) Potting soil (65 Dacron/35 Cotton)

(3) Bandy black (65 Dacron/35 Cotton)

Oxidizables:

(1) Blueberry pie (Cotton)

(2) Grape juice (65 Dacron/35 Cotton)

(3) Coffee (65 Dacron/35 Cotton)

Enzymes:

(1) Pigs blood (Cotton)

(2) Chocolate pudding (65 Dacron/35 Cotton)

(3) Grass (65 Dacron/35 Cotton)

Oily:

(1) Spangler Sebum/part. (65 Dacron/35 Cotton)

(2) Spangler Sebum/part. (Spun Nylon)

(3) Liquid Makeup (65 Dacron/35 Cotton)

The detergency as measured by the % SRI for the above-described compositions is shown in Table 2.

TABLE 2

| Composition | Clays | Oxidizables | Enzymes | Oily |
|---|---|---|---|---|
| Control | 51 | 66 | 71 | 68 |
| A | 51 | 67 | 70 | 72 |
| B | 48 | 64 | 68 | 70 |

Based on the data above, the composition of the invention, A provided approximately the same level of detergency as the Control composition notwithstanding that composition A contained substantially smaller amounts of sodium tripolyphosphate builder relative to the Control as well as being added to the wash at lower dosage levels.

### EXAMPLE 2

The performance of two detergent compositions in accordance with the invention (C and D) was evaluated relative to three Control compositions (Control-1, Control-2 and Control-3) to measure the effect on detergency of the following variables: a triblock copolymer in accordance with the invention; a lesser amount of tripolyphosphate builder; or a lesser amount of surfactant. The detergent compositions are described below in Table 3 in terms of the dosage provided to the wash solution (grams/wash).

TABLE 3

| Component | Control-1 | Control-2 | Control-3 | C | D |
|---|---|---|---|---|---|
| LAS⁽¹⁾ | 28 g/wash | 28 g/wash | 20 g/wash | 28 g/wash | 20 g/wash |
| Na TPP · | 23 | 15 | 23 | 15 | 23 |
| 6H₂O | | | | | |
| Polymer⁽²⁾ | 0 | 0 | 0 | 1.0 | 1.0 |
| Na₂SO₄ | 38.4 | 38.4 | 38.4 | 38.4 | 38.4 |
| Na₂CO₃ | 12.8 | 12.8 | 12.8 | 12.8 | 12.8 |

⁽¹⁾The linear alkyl benzene sulfonate was a sodium salt of alkyl benzene sulfonic acid having a molecular weight of approx. 375.
⁽²⁾The Pluronic ® triblock copolymer used in Compositions C and D was designated L64. This polymer is described in Example 1 at Table 1, footnote⁽²⁾.

The washing protocol of Example 1 was followed using water at 150 ppm hardness. Detergency was evaluated by comparing the total Rd values measured for the standard 12 stain set as described in Example 1 and for an oily stain set as described below.

Oily Stain Set

| Stain | Fabric |
|---|---|
| Liquid Makeup | 65 Dacron/35 Cotton |
| Spangler Sebum | 65 Dacron/35 Cotton Poplin |
| Spangler Sebum | Dacron Double Knit (DDK) |
| Barbecue Sauce | DDK |
| Barbecue Sauce | 65 Dacron/35 Cotton Poplin |
| French Dressing | DDK |
| Olive Oil | 65 Dacron/35 Cotton Poplin |
| Motor Oil | 65 Dacron/35 Cotton Poplin |
| Lard | 65 Dacron/35 Cotton Poplin |
| Chicken Fat | Cotton Percale |

Detergency as measured by total Rd for the above-described compositions is shown in Tables 4 and 5. A difference of 12 Rd units is considered significant.

TABLE 4
Detergency for the Standard 12 Stain Set

| Composition | Total Rd |
|---|---|
| Control-1 | 877 |
| Control-2 | 847 |
| Control-3 | 864 |
| C | 864 |
| D | 881 |

TABLE 5
Detergency for the Oily Stain Set

| Composition | Total Rd |
|---|---|
| Control-1 | 685 |
| Control-2 | 676 |
| Control-3 | 679 |
| C | 689 |
| D | 688 |

The detergency data above indicates, for example, that Composition C is significantly more effective than Control-2 which is identical thereto except for the absence of the triblock polymer. The 12 stain detergency of composition D is significantly better than that of Control-3. Similarly, Composition D which contained substantially less anionic surfactant than Control-1 but contained a triblock copolymer, provided equal or better detergency for both the standard stains and the oily stains. When comparing Composition D to Control-2 which contained more surfactant but less builder than Composition D, Composition D provided significantly improved detergency for both the standard and oily sets of stains.

### EXAMPLE 3

A study was conducted to compare the effect on detergency of a Pluronic® triblock copolymer in accordance with the invention in compositions containing respectively, linear alkyl benzene sulfonate (LAS); a combination of LAS and an alcohol ethoxylate (AE); and an alcohol ethoxy sulfate (AEOS).

Three test compositions (E, F, and G) containing L64 Pluronic® copolymer were prepared along with three control compositions (in the absence of polymer) as shown in Table 6. The detergent compositions are described in terms of the dosage provided to the wash solution (grams/wash).

TABLE 6

| | (LAS) | (LAS) | (LAS/AE) | (LAS/AE) | (AEOS) | (AEOS) |
|---|---|---|---|---|---|---|
| Component | Control-1 | E | Control-2 | F | Control-3 | G |
| LAS⁽¹⁾ | 20 g/wash | 20 g/wash | 13.91 g/wash | 13.91 g/wash | — | — |
| AE⁽²⁾ | — | — | 6.09 | 6.09 | — | — |
| AEOS⁽³⁾ | — | — | — | — | 20 | 20 |
| L64⁽⁴⁾ | — | 1 | — | 1 | — | 1 |
| Polymer | | | | | | |
| NaTPP | 23 | 23 | 23 | 23 | 23 | 23 |
| Na₂SO₄ | 38.4 | 38.4 | 38.4 | 38.4 | 38.4 | 38.4 |
| Na₂CO₃ | 12.8 | 12.8 | 12.8 | 12.8 | 12.8 | 12.8 |
| ΔL*⁽⁵⁾ | | 12.1 | | 3.3 | | 3.0 |

⁽¹⁾LAS is a sodium salt of alkyl benzene sulfonic acid having a molecular weight of 375.
⁽²⁾AE is Neodol 25-7 marketed by Shell Chemical Company.
⁽³⁾AEOS is sodium alcohol ethoxy sulfate (3EO) having a molecular weight of 432.
⁽⁴⁾L64 is a Pluronic ® copolymer described in Example 1, Table 1, footnote⁽²⁾.
⁽⁵⁾ΔL* is the difference in reflectance measured with a Hunter Sphere Spectrophotometer for (Composition E minus Control-1) or (F minus Control-2) or (G minus Control-3). A value of ΔL* greater than 6 is considered significant for the 12 stain set employed in this study.

As evidenced by the data in Table 6 the value of ΔL* indicates a significant increase in detergency only for Composition E which is based on LAS. For Composition F based on a mixed active system of LAS and AE, and for Composition G based on AEOS, the addition of the L64 polymer provided only a minor or insignificant improvement in detergency relative to the corresponding Control compositions.

### EXAMPLE 4

The performance of two detergent compositions in accordance with the invention (J and K) was evaluated relative to a Control composition (Control-1) to demonstrate the effect on detergency of using a triblock copolymer in accordance with the invention at the relatively low level of 0.5 grams/wash concomitant with the use of a reduced amount of tripolyphosphate builder. The detergent compositions are described below in Table 7 in terms of dosage provided to the wash solution.

TABLE 7

| Component | Control-1 | J | K |
|---|---|---|---|
| LAS⁽¹⁾ | 28 g/wash | 28 g/wash | 28 g/wash |
| Na TPP · 6H₂O | 23 | 15 | 15 |
| Triblock Polymer⁽²⁾ | 0 | 0.5 | 0.5 |
| Na₂SO₄ | 38.4 | 38.4 | 38.4 |
| Na₂CO₃ | 12.8 | 12.8 | 12.8 |

⁽¹⁾The linear alkyl benzene sulfonate was a sodium salt of alkyl benzene sulfonic acid having a molecular weight of approx. 375.
⁽²⁾Composition J contained the Pluronic ® surfactant (polymer) designated L64, and Composition K contained the Pluronic ® surfactant designated F68. Both are described in Table 1 at footnote⁽²⁾.

The washing protocol of Example 1 was followed. Detergency was evaluated using the oily stain set described in Example 2. Detergency was measured by comparing the total Rd values. A difference of 12 Rd units is considered significant for this study. The detergency results are shown in Table 8.

TABLE 8
Detergency for the Oily Stain Set

| Composition | Total Rd |
|---|---|
| Control-1 | 714 |
| J | 718 |
| K | 721 |

Based on the data in Table 8, Compositions J and K perform at parity (or better) relative to the Control-1 which contains a relatively higher level of builder.

What is claimed is:

1. A granular laundry detergent composition comprising
(a) from about 1 to about 60% by weight of an anionic surfactant consisting essentially of a water-soluble salt of an alkyl benzene sulfonate;
(b) from 0.2% to no greater than 2%, by weight, of a water-soluble triblock copolymer nonionic surfactant comprising groups of polyethylene oxide and polypropylene oxide having the following structural formula:
(I) Aₓ B_{y} A_{z} or (II) Bₓ A_{y} B_{z} wherein A is a polyethylene oxide group, B is a polypropylene oxide group and each of x, y and z is a number within the range of from one to about 85, the molecular weight of the triblock copolymer being in the range of from about 1,000 to about 15,000 and the percentage, by weight, of polyethylene oxide in said triblock copolymer is from about 10 to about 80% of the molecular weight of the copolymer; and wherein said laundry detergent composition is free of (i) any anionic and nonionic surfactant other than as defined in (a) and (b) hereinabove, and (ii) free of any fatty acids; and
(c) from 0% to about 50%, by weight, of a detergent builder.

2. A laundry detergent composition in accordance with claim 1 wherein said anionic surfactant is an ammonium or substituted ammonium or alkali metal or alkaline earth metal salt of an alkyl benzene sulfonate containing from about 10 to 16 carbon atoms in the alkyl group.

3. A laundry detergent composition in accordance with claim 2 wherein said anionic surfactant is sodium linear alkyl benzene sulfonate which contains 12 or 13 carbon atoms in the alkyl group.

4. A laundry detergent composition in accordance with claim 1 wherein said triblock copolymer has the structural formula described in (II).

5. A laundry detergent composition in accordance with claim 4 wherein the triblock copolymer has an average molecular weight of about 2,900, and a percentage by weight of polyethylene oxide of about 40%.

6. A laundry detergent composition in accordance with claim 4 wherein the triblock copolymer has an average molecular weight of about 8,400, and a percentage by weight of polyethylene oxide of about 80%.

7. A laundry detergent composition in accordance with claim 4 wherein the average molecular weight of the copolymer is within the range of from about 1,100 to about 8,400.

8. A laundry detergent composition in accordance with claim 1 which contains from about 15 to about 40 wt% of said salt of alkyl benzene sulfonate.

9. A laundry detergent composition in accordance with claim 1 wherein the effective amount of said triblock copolymer is from about 0.1 to about 10%, by weight, of said detergent composition.

10. A laundry detergent composition in accordance with claim 1 which contains from about 10% to about 50% of sodium tripolyphosphate.

11. A method of washing laundry and removing oily soils from stained fabrics which comprises washing the fabrics to be laundered in an aqueous wash solution containing an effective amount of the composition of claim 1.

12. A method of washing laundry in accordance with claim 11 wherein said anionic surfactant is sodium linear alkyl benzene sulfonate which contains 12 or 13 carbon atoms in the alkyl group.

13. A method of washing laundry in accordance with claim 11 wherein the triblock copolymer has the structural formula described in (II).

14. A method of washing laundry in accordance with claim 13 wherein the average molecular weight of the copolymer is within the range of from about 1,100 to about 8,400.
